(19) United States
(12) Patent Application Publication
(10) Pub. No.: US 2014/0028127 A1
(43) Pub. Date: Jan. 30, 2014

(54) BUSS BAR ASSEMBLY HAVING ALIGNMENT AND RETENTION FEATURE

(71) Applicants: Bradley Duane Chamberlin, Pendleton, IN (US); David Lee Durant, Anderson, IN (US)

(72) Inventors: Bradley Duane Chamberlin, Pendleton, IN (US); David Lee Durant, Anderson, IN (US)

(21) Appl. No.: 13/557,890

(22) Filed: Jul. 25, 2012

(51) Int. Cl. H02K 3/28; H02K 15/02

(52) U.S. Cl. 310/71; 29/596

(57) ABSTRACT

A buss bar assembly for electrically interconnecting phase leads extending from a plurality of individual coil winding assemblies of a stator. The buss bar body has an annular housing defining a central axis and a support for positioning the housing relative to coil winding assemblies. A phase bar disposed about the central axis is at least partially disposed within the housing and has contacts at locations about the central axis. Each contact is engageable from outside of the annular housing and angularly spaced from another contact. The buss bar assembly is adapted for installation relative to the coil winding assemblies such that the housing surrounds the stator central axis, the body axially inner face interfaces the stator coil winding assemblies, and the contacts are spaced by the support from the coil winding assemblies and engaged with phase leads. Also a method for installing a buss bar assembly.

### CROSS-REFERENCE TO RELATED APPLICATION(S)

This application is related to U.S. patent application Ser. No. ______ entitled BUSS BAR ASSEMBLY, filed on ______, 2012 (Attorney Docket No. 22888-20, D-616), the entire disclosure of which is incorporated herein by reference.

### BACKGROUND

The present disclosure relates to a rotating electrical device having a plurality of individual coil winding assemblies disposed about a stator central axis and provided with a plurality of electrical leads through which electrical power is transferred to or from the individual coil winding assemblies such as, for example, an electric motor or generator; and more specifically, to a buss bar assembly through which the phase leads are interconnected and power is transferred.

The interconnecting of phase and neutral leads extending from a plurality of individual coil winding assemblies of the stator of a rotating electrical device (e.g., a motor or generator), which are annularly arranged about the stator central axis, is often complicated and/or time consuming. Moreover, the leads and/or their connections together or to other components can, if not properly isolated electrically, result in shorting which adversely affects device reliability.

These problems are exacerbated in multi-phase devices, wherein multiple phase power and neutral leads of different phase pluralities of individual power phase coil winding assemblies must be sorted out, electrically isolated from the leads of the coil winding assemblies of the other phases, and packaged within the stator housing, all of which have the potential to adversely affect cost and reliability.

A buss bar assembly is often employed for interconnecting the various phase and neutral leads of multiple individual coil winding assemblies, and typically promotes faster, more reliable interconnecting of the leads. However, the buss bar itself must be properly oriented, packaged and installed relative to the rest of the stator, preferably within the stator housing to protect it from externally-induced damage, and preferably in a manner that facilitates automated, consistent, and proper device assembly on a mass production scale. A buss bar assembly accommodating such preferences would represent an improvement in the relevant art and provide attendant cost and reliability advantages vis-à-vis those now used in rotating electrical devices.

### SUMMARY

A buss bar assembly and installation method according to the present invention provides such advantages, and hence represents a desirable advancement in the relevant art.

The present disclosure provides a buss bar assembly for electrically interconnecting phase leads extending from a plurality of individual coil winding assemblies of a stator arranged about a stator central axis. The buss bar assembly includes a buss bar body having an annular housing defining a buss bar central axis, and has axially opposed inner and outer faces relative to the buss bar central axis. The buss bar assembly also includes a support attached to and extending from the annular housing for positioning the annular housing relative to coil winding assemblies in a direction parallel with the buss bar central axis. A substantially annular electrically conductive phase bar is disposed about the buss bar central axis, and is at least partially disposed within the annular housing. The phase bar has a plurality of electrical phase contacts at locations about the buss bar central axis. Each of the plurality of phase contacts is engageable from outside of the annular housing and angularly spaced from another of the plurality of phase contacts about the buss bar central axis. The buss bar assembly is adapted for installation relative to a plurality of coil winding assemblies arranged about a stator central axis at radial and axial locations relative to the stator central axis such that the annular housing surrounds the stator central axis, the buss bar body axially inner face interfaces the plurality of stator coil winding assemblies, and the plurality of phase contacts are spaced by the support from the coil winding assemblies along the stator central axis and engaged with phase leads extending from the coil winding assemblies.

A further aspect of this disclosure is that the buss bar assembly has an installed state relative to a plurality of coil winding assemblies arranged about a stator central axis. In the installed state the annular housing is disposed about the stator central axis, phase leads extending from the coil winding assemblies are each in electrical communication with a phase contact, the buss bar body has substantially fixed radial and axial positions relative to the stator central axis, and the buss bar body axially inner face and the plurality of phase contacts are spaced from the coil winding assemblies, whereby electrical shorts between the phase contacts and the coil winding assemblies are precluded and air circulation between the buss bar body and the coil winding assemblies is facilitated in the installed state.

Another aspect of this disclosure is that the annular housing may define the buss bar body axially inner face, and the support may extend from the housing at least one of radially outwardly of the buss bar central axis and substantially parallel with the buss bar central axis, and that in the installed state the support may engage a coil winding assembly, and the plurality of phase contacts and the buss bar body axially inner face may be spaced from the coil winding assemblies by the support.

The support may define a buss bar registration feature adapted for interengagement with a cooperating coil winding assembly registration feature in the installed state.

In the installed state the axial location of the buss bar assembly along the stator central axis may be substantially fixed by interengagement between the buss bar registration feature and the cooperating coil winding assembly registration feature.

The buss bar registration feature may include one of an aperture and a pin that, in the installed state, is interengaged with one of a cooperating pin and a cooperating aperture, respectively, of a coil winding assembly.

The support and the annular housing may be integral and substantially consist of a molded dielectric material.

In another aspect of this disclosure, the annular buss bar housing may define an outer circumference of the buss bar body, and the support may define a plurality of legs spaced about the buss bar body outer circumference.

In the installed state the buss bar body and the plurality of coil winding assemblies may have an interposed air gap defined by the plurality of legs for facilitating air circulation about the coil winding assemblies, the air gap at least partially traversed by phase leads extending from the coil winding assemblies.

At least one of the plurality of legs may include a pilot feature, with the orientation of the buss bar assembly about the stator central axis in the installed state being defined by cooperative interengagement between a coil winding assembly and the pilot feature.

At least one of the plurality of legs may include an interlocking feature, with the buss bar assembly adapted to be retained in the installed state through interengagement of a coil winding assembly and the interlocking feature, whereby the position of the buss bar assembly relative to the plurality of coil winding assemblies along the stator central axis is substantially fixed in the installed state.

A further aspect of this disclosure is that the support may include a plurality of legs extending from the buss bar body in at least one of radially outwardly of the buss bar central axis and in a direction generally along the buss bar central axis.

A further aspect of this disclosure is that the buss bar assembly may be adapted for being held in place relative to a plurality of coil winding assemblies arranged about a stator central axis by retaining forces applied to the support both radially and axially relative to the buss bar central axis.

The buss bar assembly may also be for electrically interconnecting neutral leads extending from coil winding assemblies of a stator, and a further aspect of this disclosure is that the buss bar assembly may also include a substantially annular electrically conductive neutral bar substantially surrounding the buss bar central axis, electrically isolated from the phase bar within the buss bar assembly, with the neutral bar at least partially disposed within the buss bar body and having a plurality of neutral contacts at locations about the buss bar central axis. The neutral contacts may be engageable from outside of the buss bar body and angularly spaced from each other about the buss bar central axis. The buss bar assembly may be further adapted for installation relative to a plurality of coil winding assemblies arranged about a stator central axis such that the plurality of neutral contacts is spaced from stator coil winding assemblies along the stator central axis and engaged with neutral leads extending from the coil winding assemblies.

A further aspect of this disclosure is that the buss bar body may be a plastic dielectric material that has been over-molded relative to the phase bar.

A further aspect of this disclosure is that in the installed state the buss bar central axis may substantially coincide with the stator central axis.

The present disclosure also provides a buss bar assembly for electrically interconnecting phase leads extending from a plurality of individual first phase coil winding assemblies of a stator arranged about a stator central axis. The buss bar assembly includes a substantially annular dielectric buss bar body defining a buss bar central axis, and a substantially annular first phase bar disposed about the buss bar central axis and at least partially disposed within the buss bar body. The first phase bar has contact locations about the buss bar central axis at which are first phase bar electrical connection terminals engagable from outside of the buss bar body. The first phase bar contact locations are fixed relative to the buss bar body. The buss bar assembly has an installed state relative to a plurality of individual first phase coil winding assemblies in which its phase leads are connected to the first phase bar electrical connector terminals at the first phase bar contact locations, the buss bar body is disposed about the stator central axis, and the first phase bar contact locations are spaced from the coil winding assemblies along the stator central axis.

The buss bar assembly may also be for interconnecting neutral leads extending from the plurality of arranged first phase individual coil winding assemblies, and a further aspect of this disclosure is that a substantially annular neutral bar may be disposed about the buss bar central axis and at least partially disposed within the buss bar body, with the neutral bar having contact locations about the buss bar central axis at which are neutral bar electrical connection terminals engagable from outside of the buss bar body. The neutral bar contact locations may be fixed relative to the buss bar body, with the neutral bar and the first phase bar electrically isolated from each other within the buss bar assembly. In the installed state, neutral leads of the coil winding assemblies may be connected to the neutral bar electrical connector terminals, with the neutral bar contact locations spaced from the coil winding assemblies along the stator central axis.

The buss bar assembly may also be for interconnecting phase leads extending from respective pluralities of individual second, and third phase coil winding assemblies arranged about the stator central axis, and a further aspect of this disclosure is that a substantially annular second phase bar may be disposed about the buss bar central axis and at least partially disposed within the buss bar body, with the second phase bar having contact locations about the buss bar central axis at which are second phase bar electrical connection terminals engagable from outside of the buss bar body, and the second phase bar contact locations fixed relative to the buss bar body. A further aspect of this disclosure is that a substantially annular third phase bar may be disposed about the buss bar central axis and at least partially disposed within the buss bar body, with the third phase bar having contact locations about the buss bar central axis at which are third phase bar electrical connection terminals engagable from outside of the buss bar body, the third phase bar contact locations fixed relative to the buss bar body, and the first, second, and third phase bars electrically isolated from each other. In the installed state, phase leads of first, second, and third phase coil winding assemblies may be respectively connected to the first phase bar, second phase bar, and third phase bar at their respective contact locations, and the second phase bar and third phase bar contact locations spaced from the coil winding assemblies along the stator central axis.

The buss bar assembly may also be for interconnecting neutral leads extending from the pluralities of individual first, second, and third phase coil winding assemblies, and may include a substantially annular neutral bar disposed about the buss bar central axis and at least partially disposed within the buss bar body, with the neutral bar having contact locations about the buss bar central axis which are neutral bar electrical connection terminals engagable from outside of the buss bar body, the neutral bar contact locations fixed relative to the buss bar body, and the neutral bar electrically isolated from each of the first, second, and third phase bars within the buss bar assembly. In the installed state, neutral leads of the first, second, and third phase coil winding assemblies may be in electrical communication with the neutral bar at its contact locations, and the neutral bar connector locations spaced from the coil winding assemblies along the stator central axis.

A further aspect of this disclosure is that the buss bar body may include an annular housing within which the first phase bar is at least partially disposed and a plurality of legs extending from the housing in a direction along the buss bar central axis, with the legs adapted for being disposed between the housing and the plurality of coil winding assemblies in the installed state, whereby the first phase bar is electrically connected to coil winding assemblies only through phase leads extending between the coil winding assemblies and the first phase bar contact locations.

The present disclosure also provides a method for installing a buss bar assembly to an arranged plurality of individual coil winding assemblies defining a stator central axis. The method includes the steps of: positioning a substantially annular dielectric housing of the buss bar assembly about the stator central axis; relatively moving the buss bar assembly and the plurality of coil winding assemblies towards each other along the stator central axis and superposing the annular housing and the coil winding assemblies; registering a support that extends from the housing with a coil winding assembly, thereby establishing relative radial and axial positions of the housing and the arranged plurality of coil winding assemblies; interconnecting a plurality of phase leads that extend from the plurality of individual coil winding assemblies through a substantially annular phase bar at least partially disposed in the dielectric housing through electrical phase contacts at locations outside of the housing; and retaining the buss bar assembly to the arranged plurality of coil winding assemblies through the support.

A further aspect of this disclosure is that the step of registering may include as step of engaging the support and the arranged plurality of coil winding assemblies at a plurality of discrete locations about the stator central axis on the arranged plurality of coil winding assemblies.

A further aspect of this disclosure is that the step of registering may include a step of registering a plurality of legs of the support that extend at least one of radially outwardly from the substantially annular housing and axially along the stator central axis, with the arranged plurality of coil winding assemblies at discrete locations about the stator central axis on the plurality of arranged coil winding assemblies.

The step of retaining may include steps of: positioning an annular retainer about the stator central axis; disposing the retainer about the support and into engagement with the support; and securing the retainer relative to the arranged plurality of coil winding assemblies.

A further aspect of this disclosure is that the step of registering may include a step of interengaging a pilot feature of one of the support and the arranged plurality of coil winding assemblies, and a mating receiving feature of the other of the support and the arranged plurality of coil winding assemblies.

The step of retaining may include a step of deforming at least one of the mating pilot and receiving features such that their relative movements out of interengagement is restricted by the deformation.

The step of registering may include a step of inserting the end of a pin that extends from one of a coil winding assembly and the support axially in a direction substantially parallel with the stator central axis through a mating aperture in the other of the coil winding assembly and the support; and the step of retaining may include a step of deforming the pin to a dimension larger than the size of the aperture in which the pin was inserted, thereby preventing withdrawal of the pin from the aperture.

A further aspect of this disclosure is that the steps of registering and interconnecting may be performed substantially simultaneously.

A further aspect of this disclosure is that it may also include a step of interconnecting a plurality of neutral leads that extend from the plurality of individual coil winding assemblies to a substantially annular neutral bar at least partially disposed in the dielectric housing through electrical neutral contacts at locations outside of the housing.

The step of interconnecting a plurality of phase leads and the step of interconnecting a plurality of neutral leads may be performed substantially simultaneously.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 is an axially outer perspective view of an arranged plurality of individual coil winding assemblies disposed about a stator central axis;

FIG. 2 is an enlarged, axially outer perspective view of one of the plurality of individual coil winding assemblies shown in FIG. 1;

FIG. 3 is a partial, cross sectioned, perspective view of the plurality of individual coil winding assemblies shown in FIG. 1 disposed within a stator housing, and a rotor adapted for rotation about the stator central axis;

FIG. 4 is an axially outer perspective view of a first embodiment bus bar assembly, showing in dashed lines the portions of its component first, second, and third phase bars that are located within its overmolded body;

FIG. 5 is an enlarged, partial, cross sectioned, perspective view of the first embodiment buss bar assembly shown in FIG. 4;

FIG. 6A is an axially outer perspective view of the first phase bar of the first embodiment phase bar assembly shown in FIGS. 4 and 5;

FIG. 6B is an axially outer perspective view of the second phase bar of the first embodiment phase bar assembly shown in FIGS. 4 and 5;

FIG. 6C is an axially outer perspective view of the third phase bar of the first embodiment phase bar assembly shown in FIGS. 4 and 5;

FIG. 7 is a partial, cross sectioned, perspective view similar to FIG. 3, showing the first embodiment buss bar assembly of FIG. 4 and the coil winding assembly arrangement of the stator in a mutually registered position;

FIG. 8 is a partial, cross sectioned, side view of the mutually registered first embodiment buss bar assembly and coil winding assembly arrangement shown in FIG. 7;

FIG. 9 is an axially outer perspective view of a variant first embodiment bus bar assembly shown in FIGS. 4, 5, 7, and 8, that also includes a neutral bar partially disposed within the overmolded buss bar body;

FIG. 10 is an enlarged, partial, cross sectioned, perspective view of the variant first embodiment buss bar assembly shown in FIG. 9;

FIG. 11 is an axially outer perspective view of the neutral bar of the first embodiment phase bar assembly variant shown in FIGS. 9 and 10;

FIG. 12 is an axially outer perspective view of the variant first embodiment buss bar assembly shown in FIGS. 9 and 10 and an arranged plurality of individual coil winding assemblies disposed about a stator central axis, mutually registered;

FIG. 13 is an axially outer, exploded perspective view of the mutually registered variant buss bar assembly and coil winding assembly arrangement shown in FIG. 12, and a retainer;

FIG. 14 is an axially outer, perspective view of the installed state of the variant buss bar assembly relative to the coil winding assembly arrangement, and retained by the retainer shown in FIG. 13;

FIG. 15 is a partial, cross-sectioned, side view similar to FIG. 8, showing the first embodiment buss bar assembly in its installed state relative to the coil winding assembly arrangement;

FIG. 16 is an axially outer, perspective view of a second embodiment buss bar assembly;

FIG. 17 is an enlarged, partial, cross sectioned, perspective view of the second embodiment buss bar assembly shown in FIG. 16;

FIG. 18 is a partial, cross sectioned, perspective view of one configuration of a coil winding assembly arrangement adapted for installation thereto of the second embodiment buss bar assembly shown in FIGS. 16 and 17;

FIG. 19 is a partial, cross sectioned, perspective view of the second embodiment buss bar assembly shown in FIGS. 16 and 17, and the coil winding assembly arrangement shown in FIG. 18, mutually registered;

FIG. 20 is similar to FIG. 19, but shows the second embodiment buss bar assembly of FIGS. 16 and 17 in an installed state, retained to the coil winding assembly arrangement of FIG. 18;

FIG. 21 is a partial, cross sectioned, perspective view of an alternative configuration of a coil winding assembly arrangement adapted for installation thereto of the second embodiment buss bar assembly shown in FIGS. 16 and 17; and

FIG. 22 is a partial, cross sectioned, perspective view of the second embodiment buss bar assembly shown in FIGS. 16 and 17 in an installed state, retained to the coil winding assembly arrangement shown in FIG. 21.

Corresponding reference characters indicated corresponding parts throughout the several views. Although the drawings represent an embodiment, the drawing are not necessarily to scale or to the same scale and certain features may be exaggerated in order to better illustrate and explain the present invention.

### DETAILED DESCRIPTION OF EXEMPLARY EMBODIMENT(S)

The embodiments described below are not intended to be exhaustive or to limit the invention to the precise forms disclosed in the following detailed description. Rather, the embodiments are chosen and described so that others skilled in the art may appreciate and understand the principles and practices of the present invention.

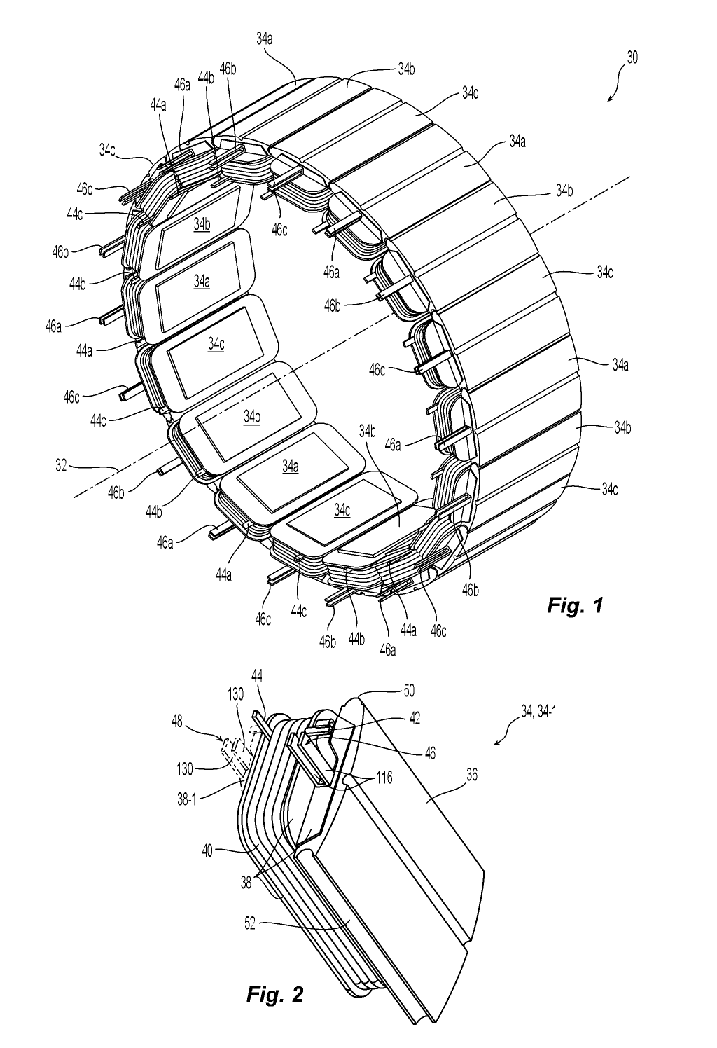

FIG. 1 shows a plurality 30 of individual coil winding assemblies arranged about a stator central axis 32, and forms part of a stator for a rotating electric device. The depicted stator includes eighteen identical individual coil winding assemblies 34, arranged in pluralities of first, second, and third phase coil winding assemblies 34a, 34b, and 34c, respectively, each plurality evenly distributed about the stator central axis 32. The characterization as a first, second, or third phase coil winding assembly is relative to the other coil winding assemblies in the stator, and may or may not be established prior to final assembly of the rotating electric device of which the stator is a part. Referring to FIG. 2, one of the individual coil winding assemblies 34 is shown, and may be a first, second, or third phase coil winding assembly 34a, 34b, or 34c. Also shown in FIG. 2 is a variant, coil winding assembly 34-1 discussed further below.

The coil winding assemblies 34 each include a segmented stack 36 of ferrous laminae that, combined together in the arranged plurality 30 of coil winding assemblies, at least partially form the stator iron. Each laminae stack 36 has an over-molded insulator 38 of a suitable thermoplastic material, and a wire coil 40 that is wound about the insulator 38. The wire coil 40 has a first, phase lead end 42 and an opposite second, neutral lead end 44.

A phase lead terminal 46 is provided at each first, phase lead end 42. As shown in FIG. 1, phase lead terminals 46a, 46b, and 46c, and neutral leads 44a, 44b, and 44c, extend from each of the first, second, and third phase coil winding assemblies 34a, 34b, and 34c, respectively. Relative to the coil winding assembly arrangement 30, circumferentially adjacent phase lead terminals 46 are spaced 20° from each other about the stator central axis 32. The neutral lead ends 44 are shown truncated in FIG. 1.

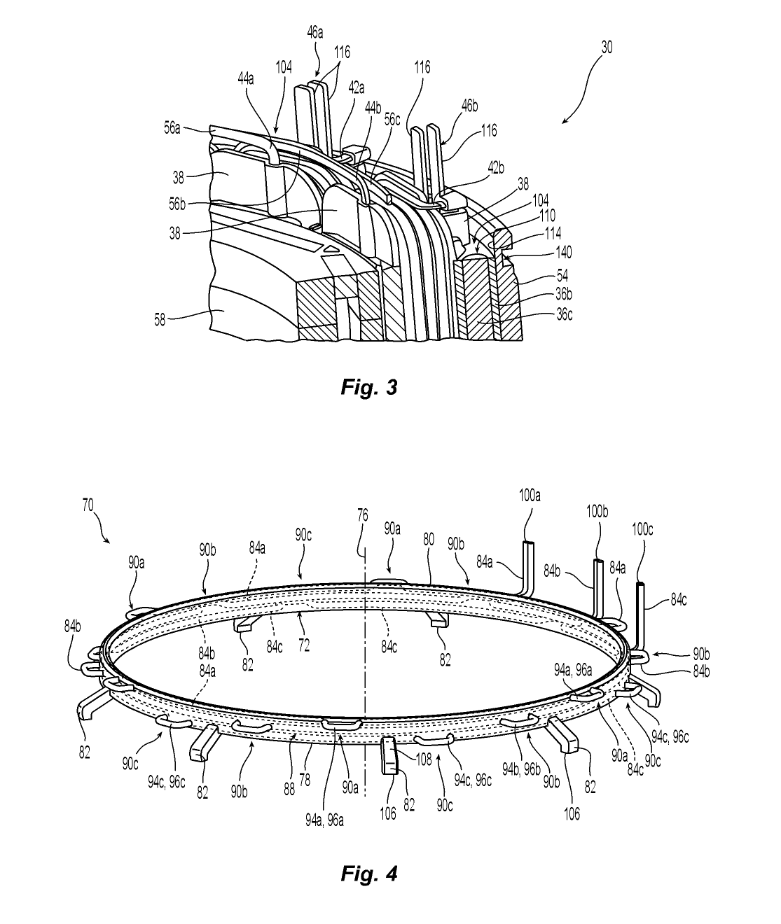

Each segmented laminae stack 36 includes a tongue 50 on one elongate, lateral edge, and a groove 52 on the opposite elongate, lateral edge; the tongue 50 and groove 52 of adjacent coil winding assemblies are interfitted to define the annular arrangement 30 of coil winding assemblies 34. The arranged plurality 30 of coil winding assemblies 34 is disposed within a cylindrical stator housing 54, shown in FIG. 3, and the neutral lead ends 44 of the coil winding assemblies 34 continuously extend into neutral lead portions 56 that are arcuately wrapped about the stator central axis 32 within the stator housing 54. The extended neutral lead portions 56 are electrically connected to each other, and to a common neutral terminal of the stator (not shown). As shown in FIG. 3, the extended neutral lead portions 56a, 56b, and 56c extend continuously from the second, neutral lead ends 44a, 44b, 44c of the first, second, and third coil winding assemblies 34a, 34b, and 34c, respectively. FIG. 3 also shows a rotor 58 surrounded by the arranged plurality 30 coil winding assemblies 34 and is adapted for rotation about the stator central axis 32.

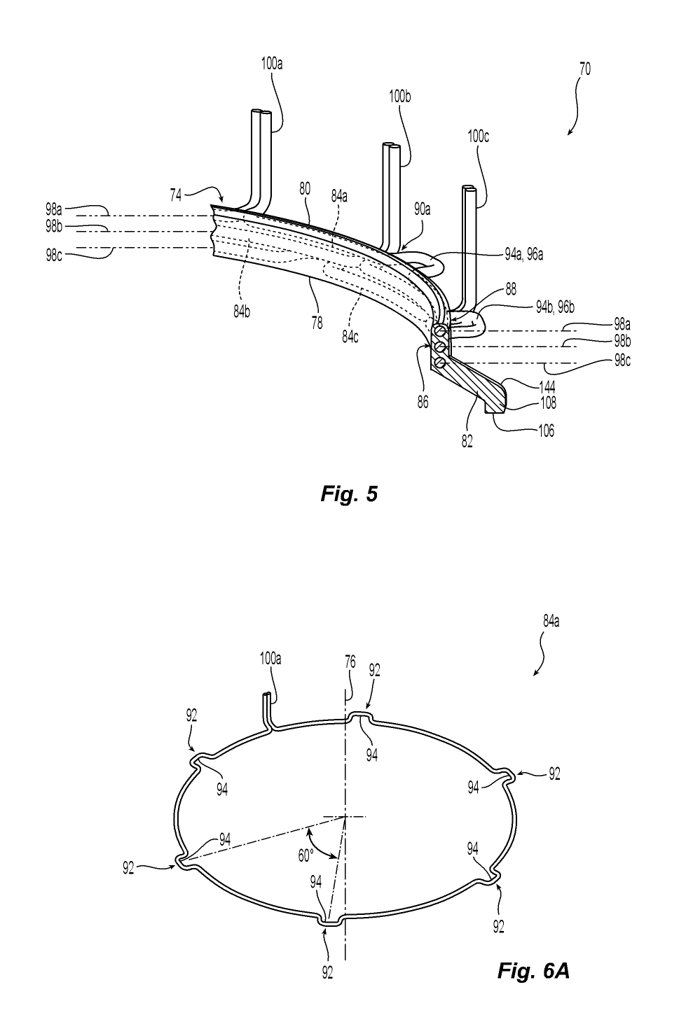

FIGS. 4 and 5 show a first embodiment buss bar assembly 70 that includes a dielectric, injection molded thermoplastic body 72 that includes an annular housing 74 defining a buss bar central axis 76. Buss bar body 72 has an axially inner face 78 and an opposed, axially outer face 80. Extending from the annular housing 74 is an integrally formed support 82 of the buss bar body 72. Substantially annular first, second, and third phase bars 84a, 84b, and 84c are individually electrically connectable to phase lead terminals 46a, 46b, or 46c of the respective first, second, or third phase coil winding assemblies 34a, 34b, 34c, respectively. Thus, the wire coil first, phase lead ends 42 of each plurality of first, second, and third phase coil winding assemblies 34a, 34b, or 34c are electrically interconnected through the respective phase bar 84a, 84b, or 84c. The first, second, and third phase bars 84a, 84, and 84c are axially stacked in a direction parallel with the buss bar central axis 76, and partially disposed within the annular housing 74. The phase bars 84 are out of electrical communication with each other, and are mold inserts on which the plastic buss bar body 72 is overmolded, as may be done by known injection molding techniques not discussed herein.

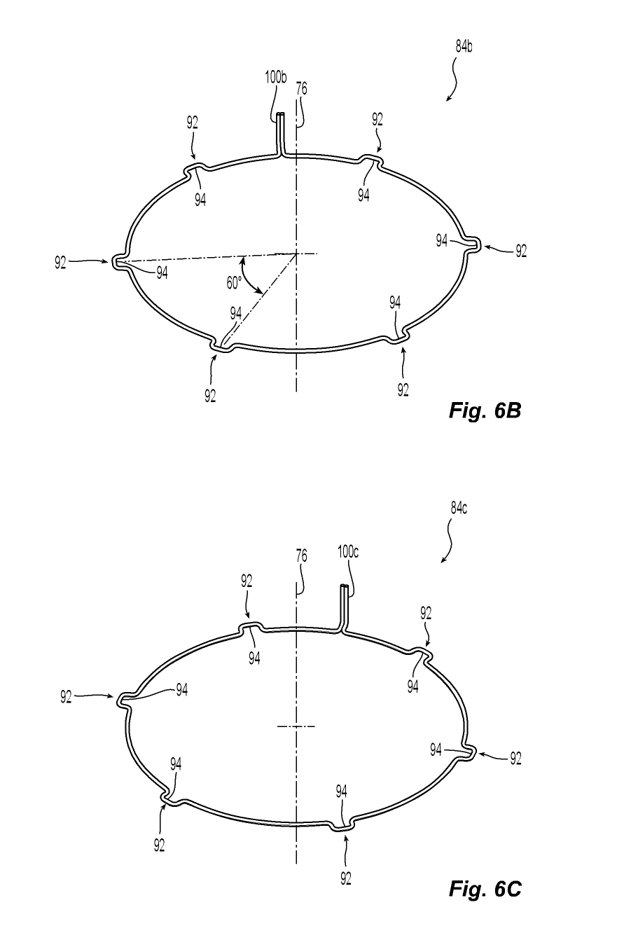

The identical first, second, and third phase bars 84a, 84b, and 84c shown in FIGS. 6A, 6B, and 6C are each centered about the buss bar central axis 76, and angularly offset relative to each other in the buss bar body 72 by 20° or 40°. Returning to FIG. 4, the buss bar annular housing 74 has a radially inner surface 86 and a radially outer surface 88. At angularly distributed locations 90 on the buss bar body 72, phase bar electrical contacts 92 are provided at which the phase bars 84 are electrically engageable from outside of the buss bar body. In the depicted embodiment, locations 90 are on radially outer surface 88. Locations 90a, 90b, and 90c are where the first, second, and third phase bar electrical contacts 92a, 92b, and 92c, respectively, are located on the buss bar body 72. Each of the phase bars 84a, 84b, and 84c is associated with a plurality of contacts 92a, 92b, and 92c, respectively. In the first embodiment buss bar assembly 70, the contacts 92 of each phase bar 84 are defined by its circumferentially extending portions 94. With reference to FIGS. 4, and 6A, 6B, or 6C, the circumferentially extending portions 94a, 94b, or 94c of the first, second, or third phase bars 84a, 84b, 84c define contacts 92a, 92b, or 92c. Each of the contacts 92 is electrically contactable from outside of the buss bar body 72, and when the buss bar assembly 70 is installed on the stator, is connected to one of the coil winding assemblies 34. Relative to each phase bar 84, each of its contacts 92 is spaced 60° from an adjacent contact 92, as shown by example in FIG. 6A. Thus, equiangularly distributing all of contacts 92 about the buss bar central axis 76 results in a 20° separation between circumferentially adjacent contacts.

At each location 90 is a phase bar electrical connection terminal 96 through which electrical communication with a respective phase bar contact 92 is established. First, second, and third phase bar electrical connection terminals 96a, 96b, 96c are located at contact locations 90a, 90b, and 90c, respectively. In the depicted first embodiment buss bar assembly 70, the phase bar electrical connection terminals 96 are defined by the phase bar circumferentially extending portions 94 themselves. Those of ordinary skill in the art will appreciate, however, that the buss bar assembly 70 may instead incorporate separate connection terminals (not shown) attached to the contacts 92, and that the phase bars 84 may themselves be entirely disposed within the buss bar housing 74.

As shown, the phase bars 84a, 84b, and 84c and their respective contacts 92a, 92b, and 92c substantially lie in a respective one of spaced, parallel imaginary planes 98a, 98b, and 98c. The planes 98 are perpendicular to and spaced along the buss bar central axis 76, as best seen in FIG. 5. Each phase bar 84 includes a phase power terminal 100 by which electrical power to or from the coil winding assemblies 34 is transferred to or from the buss bar assembly 70, as the case may be. First, second, and third phase power terminals 100a, 100b, and 100c of buss bar assembly 70 are defined by the first, second, and third phase bar 84a, 84b, and 84c, respectively, and extend outwardly away from the annular housing 74. The phase power terminals 100 may each include the circumferentially opposite ends of the respective annular phase bar 84 and is circumferentially centered between a pair of its adjacent contacts 92. Thus, the phase power terminals 100 of the three phase bars 84 are spaced from each other by either 20° or 40° about the buss bar central axis 76.

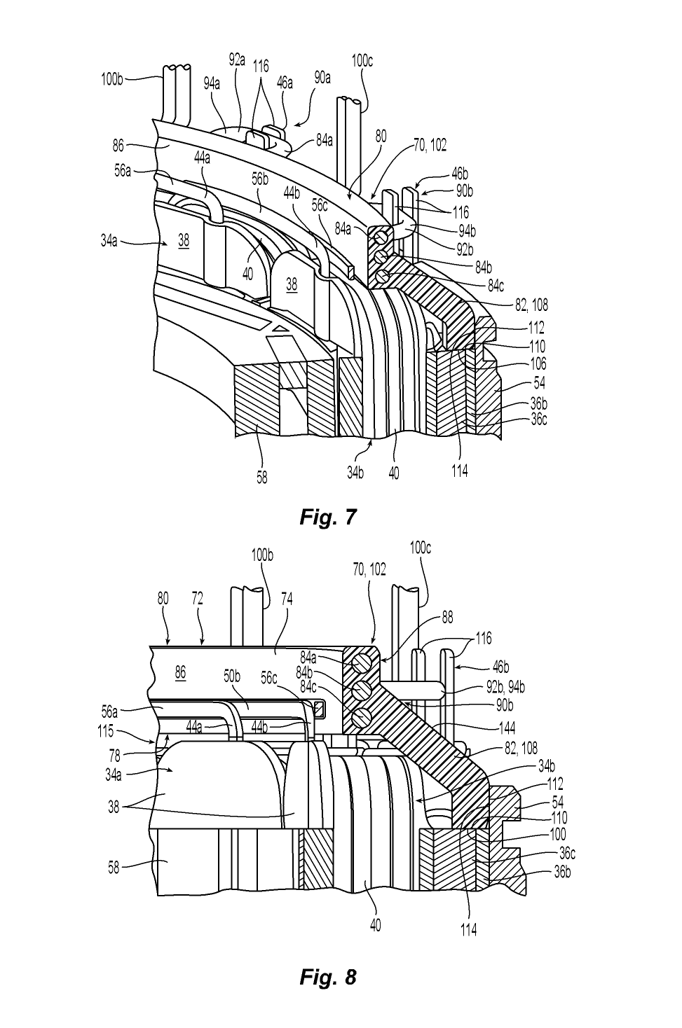

Referring to FIGS. 7 and 8, the buss bar assembly has an installed state 102 relative to the arranged plurality 30 of individual coil winding assemblies 34. In the installed state 102, the buss bar assembly 70 has a registered position relative to the arranged plurality 30 of coil winding assemblies 34 in which the buss bar body support 82 engages the axially outer face defined by the annular coil winding assembly arrangement 30 at discrete, circumferentially spaced locations 104 about the stator central axis 32. Abutting the coil winding assembly arrangement 30 at locations 104 are the terminal ends 106 of legs 108. Legs 108 define the buss bar body support 82, and extend radially and axially from the annular housing 74. The locations 104 at which the leg terminal ends 106 are located in the installed state 102 are on axially outer surfaces 110 of the segmented laminae stacks 36. The abutting engagement between leg terminal ends 106 and surfaces 110 establish an axial position of the buss bar assembly 70 relative to the coil winding assembly arrangement 30 when they are mutually registered, and which is fixed upon retaining the buss bar assembly to the stator. As perhaps best seen in FIG. 8, the legs 108 have radially outermost surfaces 112 near their terminal ends 106. Radial surfaces 112 abuttingly engage the interfacing radially inner surface 114 of the stator housing 54. The abutting engagement between surfaces 112 and 114 establishes a radial position of the buss bar assembly 70 when it and the coil winding assembly arrangement 30 are mutually is registered, and which is fixed upon retaining the buss bar assembly to the stator. The fixed axial and radial positions of the buss bar assembly 70 relative to the coil winding assembly arrangement 30 electrically isolates the contacts 92 from the coil winding assemblies 34, except through phase lead terminals 46, and provide an air gap 115 between the coil winding assembly arrangement 30 and the inner axial face 78 of the buss bar body 72 that facilitates cooling air circulation. The air gap 115 is perhaps best seen in FIG. 8. Each phase lead terminal 46 is provided with a pair of spaced blades or prongs 116 that, during registration, slidably engage a circumferentially extending portion 94 of a respective phase bar 84.

It is envisioned that, if desired, the angular orientation of the buss bar assembly 70 about the stator central axis 32 may optionally vary between any of the eighteen different positions at which the support legs 108 can abuttingly engage surfaces 110, the position of the phase power terminals 100 being most determinative of a preferred angular orientation of the buss bar assembly 70 relative to the coil winding assembly arrangement 30. Thus, as mentioned above, the characterization of a coil winding assembly 34 as a first, second, or third phase coil winding assembly 34a, 34b, or 34c may not be necessarily predetermined.

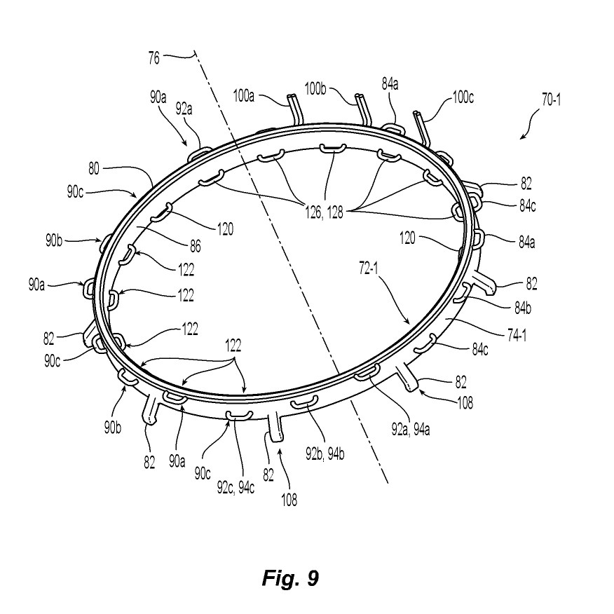

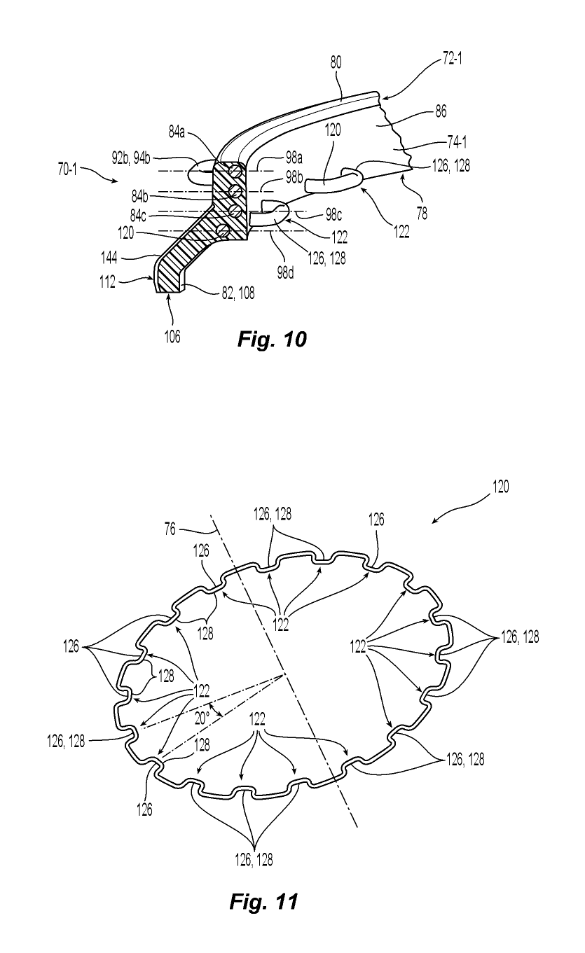

Referring to FIGS. 9 and 10, a variation of the first embodiment buss bar assembly 70 is shown. Variant buss bar assembly 70-1 is similar to buss bar assembly 70 as heretofore described, but also includes a substantially annular neutral bar 120. In buss bar assembly 70-1, electrical communication with the neutral bar 120 can be had from outside of the buss bar body 72-1 via neutral bar electrical contacts 124 at locations 122 about the buss bar central axis 76. The locations 122 of the neutral bar electrical contacts 124 are on the radially inner surface 86 defined by the buss bar annular housing 74-1. The neutral bar 120 and its contacts 124 substantially lie in a fourth plane 98d perpendicular to the buss bar axis 76 and spaced from the third plane 98c, in which the third phase bar 84c and its contacts 92c substantially lie. The neutral contacts 124 are defined by circumferentially extending portions 126 of the neutral bar 120. As depicted, in buss bar assembly 70-1 these circumferentially extending portions 126 define eighteen equiangularly distributed neutral bar electrical connection terminals 128 in a manner similar to that by which the phase bar electrical connection terminals 96 are defined by the circumferentially extending portions 94 of the phase bars 84.

Referring again to FIG. 2, each individual winding assembly 34-1 has a neutral lead terminal 48 that is rigidly affixed to its over-molded insulator 38-1. These neutral lead terminals 48 include a pair of spaced blades or prongs 130 that, during registration, slidably engage the circumferentially extending portions 126 of the neutral bar 120.

Each of the angularly distributed neutral bar contacts 124 is spaced 20° from an adjacent neutral bar contact 124. Referring to FIG. 9, it can be seen that the circumferential locations 90 and 122 of the pair of associated phase bar and neutral bar contacts 92, 124 for connection to any one coil winding assembly 34-1 are slightly out of radial alignment relative to each other, thereby accommodating the shown positioning of the coil winding assembly terminals 46 and 48; the radial alignment, or the radial spacing, between each pair of associated contact locations 90 and 122 may be varied as stator design considerations warrant.

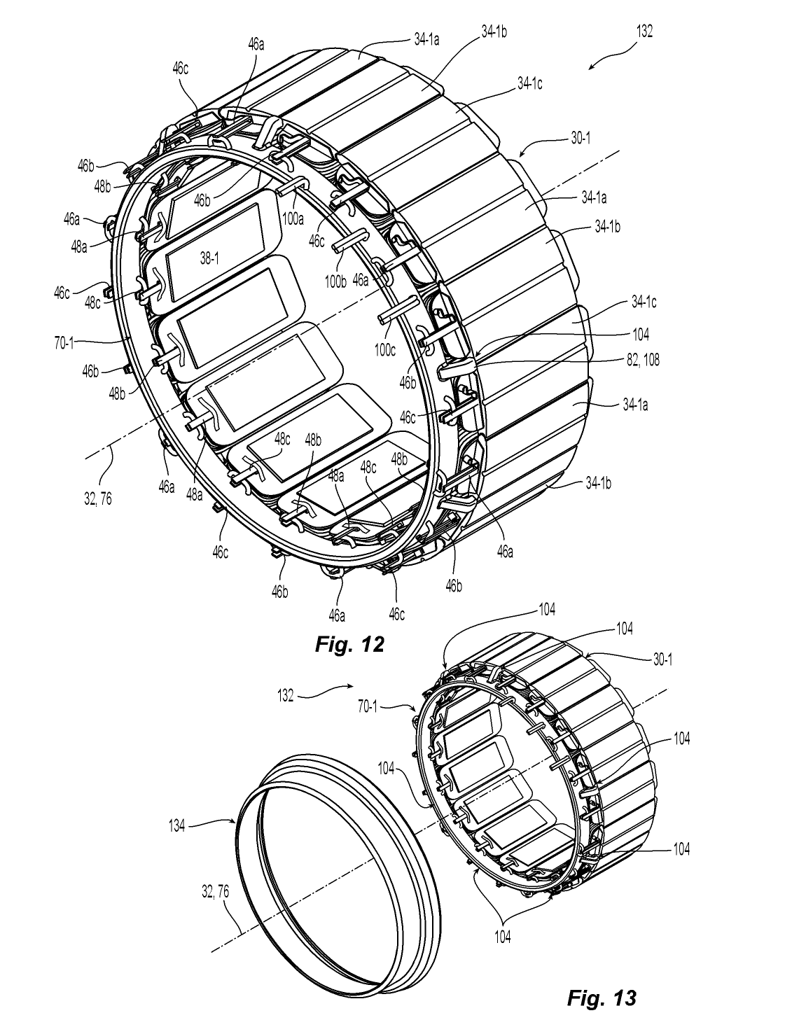

Referring to FIG. 12, subassembly 132 includes the arranged plurality 30-1 of individual coil winding assemblies 34-1 and the buss bar assembly 70-1 in a mutually registered position, prior to retaining the buss bar assembly. Subassembly 132 would also include the stator housing 54 shown in FIGS. 7 and 8, which is omitted from FIG. 12 for purposes of clarity.

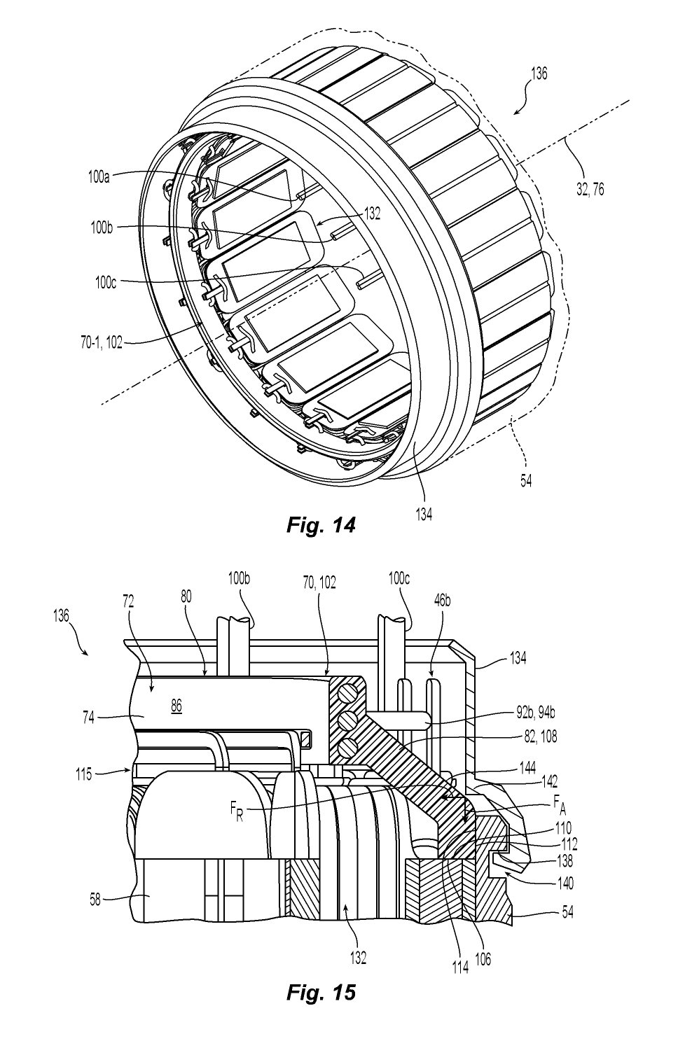

Referring to FIGS. 13-15, during assembly the step of retaining the buss bar assembly 70, 70-1 to the coil winding assembly arrangement 30, 30-1, the annular retainer 134 is positioned about the stator central axis 32 and coaxial buss bar central axis 76, and fitted over the buss bar assembly 70 or 70-1 and the arranged plurality 30 or 30-1 of coil winding assemblies. The retainer 134, once installed on the subassembly 132, forms the assembly 136 shown in FIG. 14, and retains the buss bar assembly in its installed state 102.

Referring to FIG. 15, when installed, the retainer 134 is seated onto the buss bar assembly 70 or 70-1 in a manner that engages a segmented annular lip 138 of the retainer with a circumferential groove 140 provided in the stator housing 54. The retainer 134 may be of a suitable, elastically deformable plastic that facilitates its elastic deflection to allow interconnection of the segmented lip 138 and the groove 140. The retainer 134 has an annular interior shoulder 142 that engages oblique, outwardly facing surfaces 144 of the support legs 108. The abutting engagement of the shoulder 142 and the oblique surfaces 144 imparts radial force components F_{R} and axial components F_{A} on the buss bar body 72 which retain the buss bar assembly 70, 70-1 to the arranged plurality 30, 30-1 of coil winding assemblies 34, 34-1 when the retainer lip 138 is seated in the circumferential groove 140 of the stator housing 54. Regardless of whether buss bar assembly 70 or 70-1 is used, the retainer 134 retains the buss bar assembly in fixed radial and axial positions relative to the coil winding assembly arrangement 30 or 30-1.

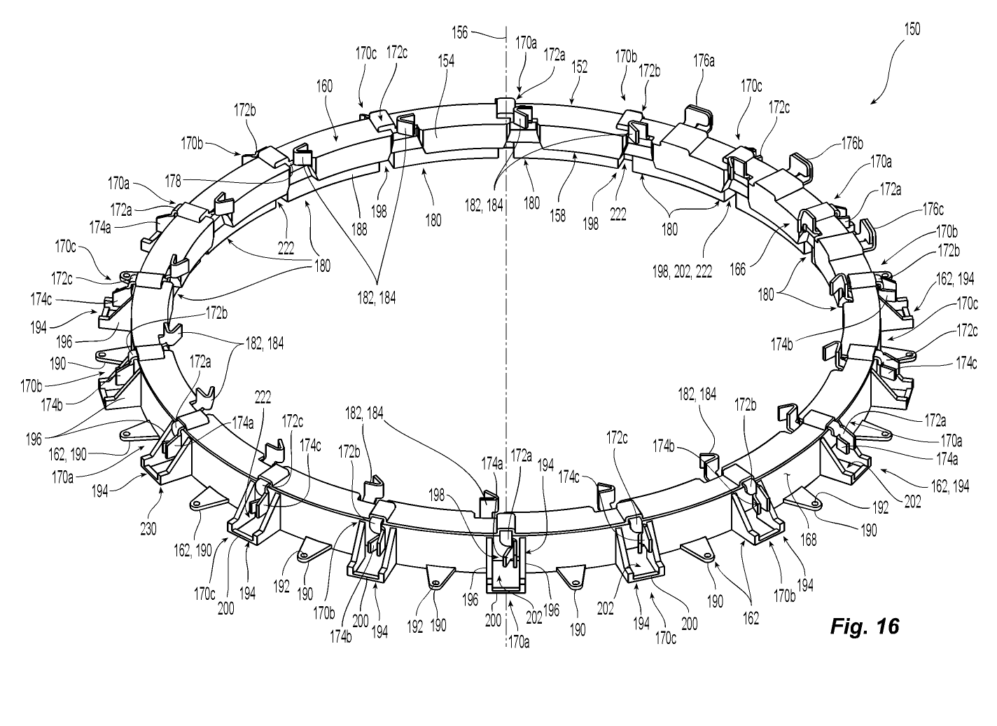

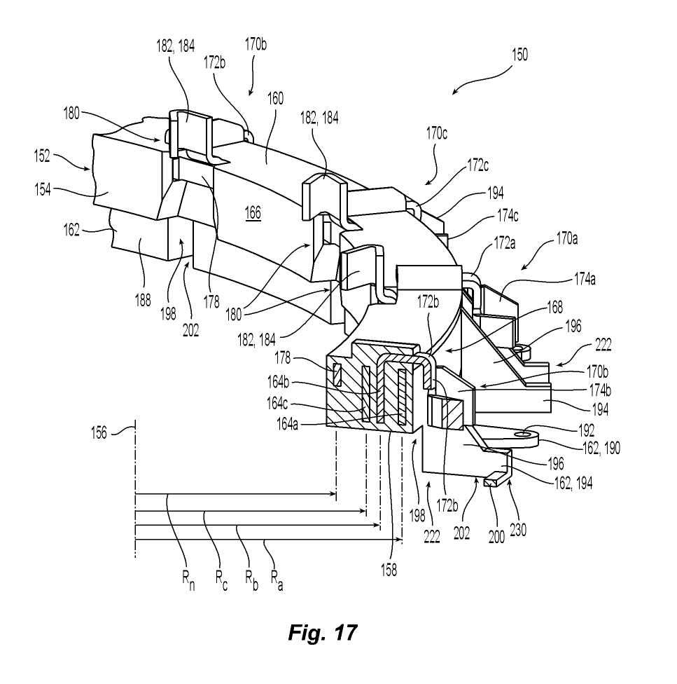

Referring to FIGS. 16 and 17, second embodiment buss bar assembly 150 has a body 152 that includes an annular housing 154 defining buss bar central axis 156, and having an axially inner face 158 and an axially outer face 160. The dielectric, injection molded thermoplastic buss bar body 152 also includes an integral support 162 that extends from the annular housing 154. Buss bar assembly 150 includes a plurality of phase bars 164 at least partially disposed within the buss bar body 152, over which the body is overmolded. As shown in FIG. 17, the first, second, and third phase bars 164a, 164b, 164c are concentric about the buss bar central axis 156 and located at radii Rₐ, R_{b}, and R_{c}, respectively. In the depicted embodiment, the phase bars 164 are stamped sheet material each formed into a ring.

Annular buss bar housing 154 includes a radially inner surface 166 and a radially outer surface 168. About the radially outer surface 168 are eighteen angularly distributed locations 170 of phase bar electrical contacts 172 electrically engageable from outside of the buss bar body 152. Each of the phase bars 164a, 164b, and 164c is associated with a plurality of contacts 172a, 172b, and 172c, respectively. Locations 170a, 170b, and 170c are where the first, second, and third phase bar electrical contacts 172a, 172b, and 172c, respectively, are located on the buss bar body 152. These locations 170 are, as in the first embodiment buss bar assembly 70, 70-1, distributed at 20° intervals about the outer circumference of the buss bar body 152. At each of locations 170 a phase bar electrical connection terminal 174 is in electrical communication with the phase bar electrical contact 172, viz., first, second, and third phase bar electrical terminals 174a, 174b, 174c are connected to phase bar electrical contacts 172a, 172b, 172c at locations 170a, 170b, 170c, respectively. In the depicted embodiment, terminals 174 are integral with their respective phase bar 164. The phase bars 164 are electrically engageable through their respective contacts 172 from outside of the body 152 of the buss bar assembly 150.

As best shown in FIG. 16, phase power terminals 176 are provided by which electrical power to or from the coil winding assemblies is transferred to or from the buss bar assembly 150, as the case may be. The first, second, and third phase power terminals 176a, 176b, and 176c, respectively, are angularly spaced from each other by either 20° or 40° about the buss bar central axis 156.

Buss bar assembly 150 optionally includes an annular neutral bar 178 of construction similar to that of the phase bars 164 and concentrically located about the buss bar central axis 156 at radius Rₙ, as shown in FIG. 17. It is to be understood that the inclusion the neutral bar 178 and its associated connection terminals 184 is optional, and may be omitted from certain variants (not shown) of the second embodiment buss bar assembly 150. In such alternative configurations, extended portions of the second, neutral leads of each individual coil winding assembly may extend circumferentially about the stator central axis in a manner similar to that shown in FIG. 3, and interconnected externally of the second embodiment buss bar assembly 150. In the depicted embodiment, however, eighteen locations 180 of neutral bar electrical contacts 182 through which the neutral bar 178 is electrically engageable are distributed about the radially inner surface 166 of the annular buss bar housing 154. At each of the neutral bar contact locations 180 is a neutral bar electrical connection terminal 184 connected to the respective contact 182. In the depicted embodiment, the neutral bar electrical connection terminal 184 and the neutral bar 178 are integral.

The buss bar assembly 150 has an installed state 186 in which its central axis 156 is coaxial with the stator central axis (not shown) and is retained to the arranged plurality of coil winding assemblies. Buss bar body support 162 includes a cylindrical skirt portion 188 that is aligned with and shares the radially outer surface 168 of the buss bar housing 154. The support 162 also includes first, substantially planar legs 190 radially extending outwardly from the radially outer surface 168 of the buss bar body 152. The first legs 190 are distributed at 20° intervals about the buss bar central axis 156. Each planar first leg 190 has an aperture 192 therethrough. The support 162 further includes second legs 194 extending both axially along and radially outwardly relative to the buss bar body radially outer surface 168. Each second leg 194 is interposed between a pair of circumferentially adjacent first legs 190, and is defined by a pair of radially and axially extending, circumferentially spaced walls 196. A slot 198 in the support skirt portion 188 is located between the pair of walls 196 of each second leg 194. Each second leg 194 includes a floor portion 200 that extends between the circumferentially spaced walls 196 near their radially outermost edges. A slot 202 is defined in each second leg 194 by the walls 196 and the floor portion 200. Axially superposing each of the slots 202 is a phase bar connection terminal 174. The slots 198 and 202 are open-ended and, relative to each second leg 194, are contiguous, thereby defining an opening through which the phase lead of a coil winding assembly may pass through the buss bar body 152.

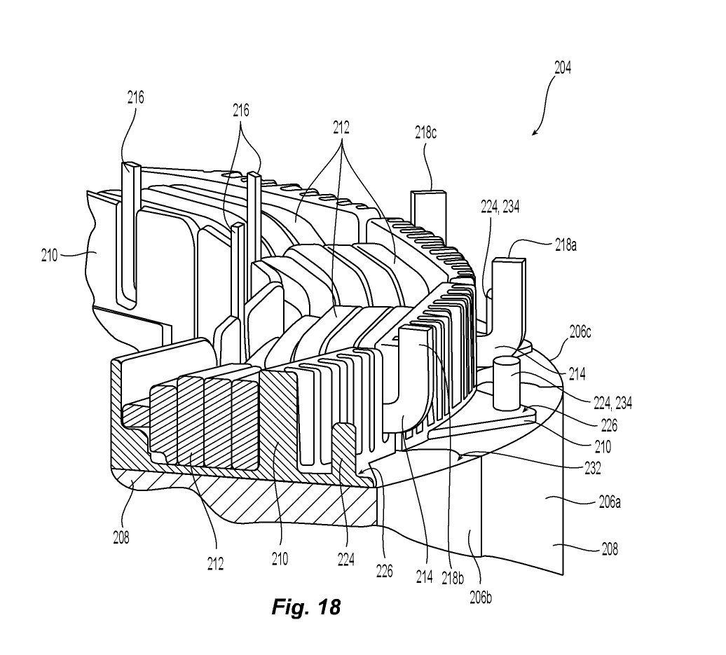

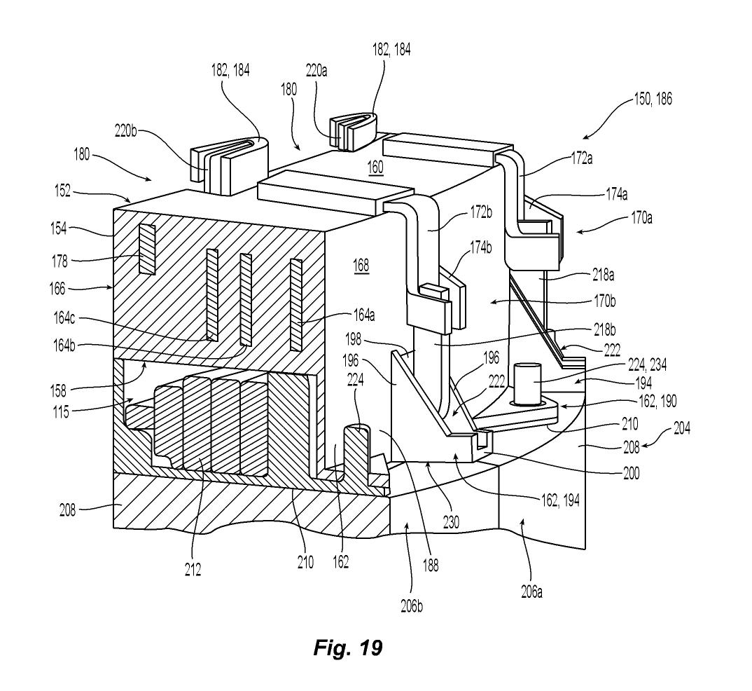

An arranged plurality 204 of individual coil winding assemblies 206 is partially shown in FIGS. 18 and 19. Eighteen individual coil winding assemblies 206, including equal pluralities of first, second, and third phase coil winding assemblies 206a, 206b, 206c are structured and arranged in a circle about the stator central axis (not shown) substantially as described above. As shown, each individual coil winding assembly 206 includes a segmented stack 208 of laminae, an over-molded thermoplastic insulator 210, and a wire coil 212. Each wire coil 212 has a first, phase lead end 214 and an opposite second, neutral lead end 216.

Connected to the first, phase lead end 214 is a phase lead terminal 218 rigidly affixed to the insulator 210 and projecting outwardly and away from the segmented laminae stack 208. Each first, second, and third phase coil winding assembly 206a, 206b, 206c includes a phase lead terminal 218a, 218b, or 218c, respectively, having an axially extending blade portion for engaging phase bar terminals 174. In the depicted embodiment, optionally provided at the second, neutral lead end 216 of each wire coil 212 is a neutral lead terminal 220 rigidly affixed to the insulator 210 and extending away from the segmented laminae stack 208. The neutral lead terminal 220 has an axially extending blade portion from engaging neutral bar terminals 184. Thus, each first, second, and third phase coil winding assembly 206a, 206b, 206c includes a rigid phase lead terminal 218a, 218b, or 218c, and may include an optional rigid neutral lead terminal 220a, 220b, or 220c. The phase lead and neutral lead terminals 218 and 220 are of blade type and fixed at positions relative to the coil winding assembly arrangement 204. The tips of the terminals 218 and 220 are located axially above the remainder of the coil winding assembly arrangement 204 as viewed in FIG. 18.

The opening defined by slots 198 and 202 in each support second leg 194 defines a pilot feature 222 for radially orienting the buss bar assembly 150 to the arranged coil winding assemblies 206. The pilot features 222 cooperate with the tips of the phase lead terminals 218 inserted through the pilot features 222. The phase lead terminals 218 thus serve as receiving features. Although one may of course conversely consider the openings defined by slots 198 and 202 as receiving features 222 and the phase lead terminals 218 as pilot features, the former characterization is adopted in the following description. The phase lead terminals 218 are mated with and accepted through the openings defined by the slots 198, 202 during assembly of the buss bar assembly 150. The buss bar assembly 150 can thus be initially and quickly oriented for subsequent registration with the arranged plurality 204 of individual coil winding assemblies 206. During registration, the phase and neutral lead terminals 218, 220 are mated with their respective aligned phase bar and neutral bar connection terminals 174, 184, and each pair of mated terminals 174, 218 and 184, 220 is subsequently secured by crimping or soldering to ensure a reliable electrical connection therebetween, once the buss bar assembly 150 and coil winding assembly arrangement 204 are mutually registered. The registration of the buss bar assembly relative to the coil winding assembly arrangement thus lends itself to automated assembly processes.

A cylindrical pin 224 is provided on each over-molded insulator 210. Relative to the stator axis, the cylindrical pins are located radially outside of the wire coil 212 locations and extend in directions parallel with the stator central axis. About the pins 224 are discrete locations 226 on the axially outer face of the coil winding assembly arrangement 204 at which the first legs 190 are seated upon registration. The apertures 192 are closely received over the cylindrical pins subsequent to the phase lead terminals 218 being accepted through the pilot features 222 defined by the slots 198, 202. Once the first legs 90 are fully received onto the pins 224, the buss bar assembly 150 is registered relative to the coil winding assembly arrangement 204. The first legs 190 each have an axially inner surface 228 that abuts the overmolded insulator 210 near the base of a cylindrical pin 224, and the second legs 194 each have an axially inner surface 230 that abuts the interfacing, axially outer face of a segmented laminae stack 208 at a discrete location 232, upon registration. Once registered, the relative axial and radial positions of the boss bar assembly 150 and the coil winding assembly arrangement 204 are established. In this registered position, the buss bar contacts 172 and connection terminals 174 are electrically isolated from the coil winding assemblies 206, except through the phase lead terminals 218; if so configured, the neutral bar contacts 182 and connection terminals 184 are electrically isolated from the coil winding assemblies 206, except through the neutral lead terminals 220. The air gap 115 between the buss bar body axially inner face 158 and the radially outer face of the coil winding assembly arrangement 204, which facilitates the circulation of cooling air therebetween, will vary with the axial height of the skirt portion 188.

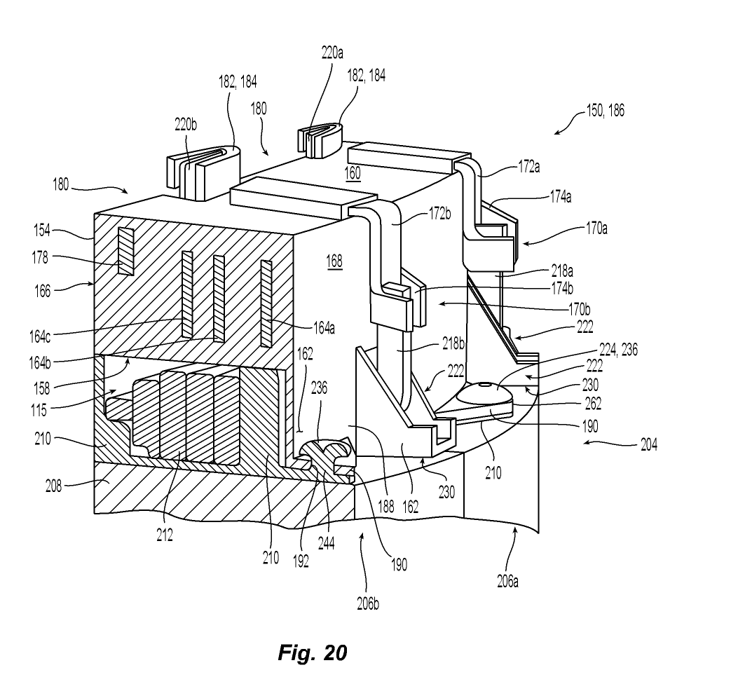

With the buss bar assembly 150 and arranged plurality 204 of coil winding assemblies 206 mutually registered, the end 234 of each cylindrical pin 224 inserted through an aperture 192 is plastically deformed by means of sonic welding, for example, to form a large diameter head 236 from the plastically deformed pin, as shown in FIG. 20. The diameter of the formed head 236 is greater than the diameter of the aperture 192, and the buss bar assembly 150 is thus retained in its installed state 186.

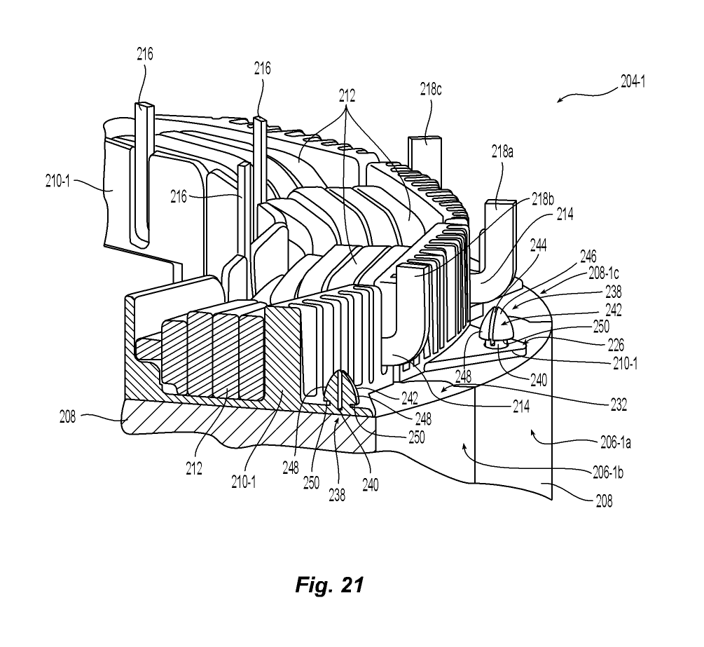

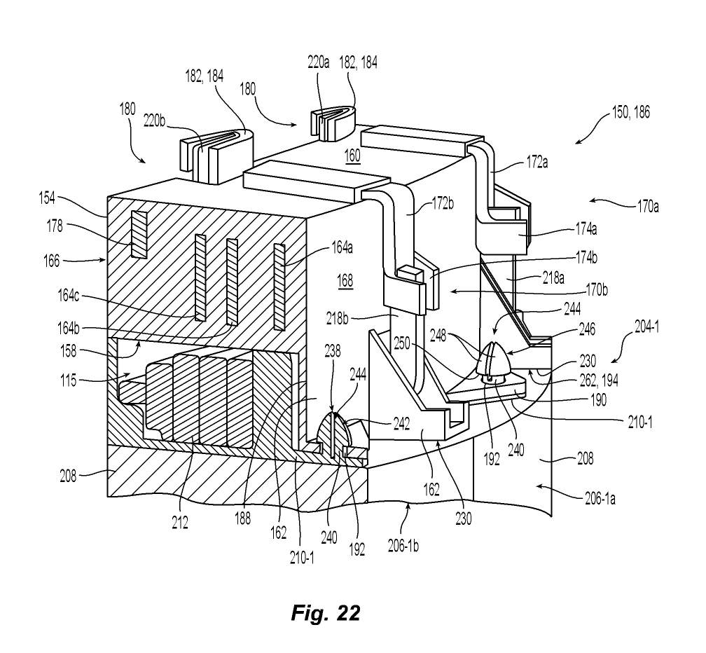

FIGS. 21 and 22 show an alternatively configured example of a coil winding assembly arrangement for use with the second embodiment buss bar assembly 150. Other than as shown and/or described herein, the arranged plurality 204-1 of individual coil winding assemblies 206-1 and the method by which the buss bar assembly 150 is installed thereto are substantially identical to those described above for the arrangement 204 of coil winding assemblies 206.

Each coil winding assembly 206-1 has an overmolded insulator 210-1. The overmolded, thermoplastic insulators 210-1 have integral, elastically deformable fasteners 238 that extend axially from locations 226 in directions parallel with the stator central axis. Each fastener 238 includes a cylindrical shank 240 of a diameter smaller than that of the apertures 192 provided in buss bar support first legs 190. Each shank 240 extends from a portion of the axially outer face of the coil winding assembly arrangement 204-1 defined by an overmolded insulator 210-1 which overlaps the axial end surface of a segmented laminae stack 208. Each fastener 238 also includes an integral, substantially frustoconical head 242 having a base centrally connected to shank 240. The major diameter at the base of the frustoconical head 242 is variable, and in its natural state is larger than the diameter of the aperture 192 provided in each first leg 190 of the buss bar assembly 150; the minor diameter of the frustoconical head 242 is smaller than the diameter of the apertures 192.

The fastener head 242 is segmented by axially extending slots 244 that extend from the tip of the head to a location in the cylindrical shank 240, along the shank central axis. The major diameter of the head 242 is reducible to a diameter small enough for the head to pass through the first leg apertures 192 by deflecting the head 242 radially inwardly upon itself, narrowing the fastener slots 244. This is done by sliding the circular edge of an aperture 192 along the frustoconical surfaces 246 of the head segments 248, thereby compressing the head segments radially inwardly, narrowing the slots 244. Once the major diameter of the head 242 passes through the aperture 192, the head is released from its deflecting compression and returns to its natural, undeflected state, reestablishing its major diameter larger than the diameter of aperture 192. The first leg 190 is retained on the shank 240 beneath the underside surfaces 250 of the fastener head segments 248, as shown in FIG. 22. The second embodiment buss bar assembly 150 is thus retained to the coil winding assembly arrangement 204-1.

While exemplary embodiments have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A buss bar assembly for electrically interconnecting phase leads extending from a plurality of individual coil winding assemblies of a stator arranged about a stator central axis, said buss bar assembly comprising:
a buss bar body having an annular housing defining a buss bar central axis, said buss bar body having axially opposed inner and outer faces relative to said buss bar central axis;
a support attached to and extending from said annular housing for positioning said annular housing relative to coil winding assemblies in a direction parallel with said buss bar central axis;
a substantially annular electrically conductive phase bar disposed about said buss bar central axis, said phase bar at least partially disposed within said annular housing and having a plurality of electrical phase contacts at locations about said buss bar central axis, each of said plurality of phase contacts engageable from outside of said annular housing and angularly spaced from another of said plurality of phase contacts about said buss bar central axis;
said buss bar assembly adapted for installation relative to a plurality of coil winding assemblies arranged about a stator central axis at radial and axial locations relative to the stator central axis such that said annular housing surrounds the stator central axis, said buss bar body axially inner face interfaces the plurality of stator coil winding assemblies, and said plurality of phase contacts are spaced by said support from the coil winding assemblies along the stator central axis and engaged with phase leads extending from the coil winding assemblies.

2. The buss bar assembly of claim 1, wherein said buss bar assembly has an installed state relative to a plurality of coil winding assemblies arranged about a stator central axis;
wherein in said installed state said annular housing is disposed about the stator central axis, phase leads extending from the coil winding assemblies are each in electrical communication with a said phase contact, said buss bar body has substantially fixed radial and axial positions relative to the stator central axis, and said buss bar body axially inner face and said plurality of phase contacts are spaced from the coil winding assemblies;
whereby electrical shorts between said phase contacts and the coil winding assemblies are precluded and air circulation between said buss bar body and the coil winding assemblies is facilitated in said installed state.

3. The buss bar assembly of claim 2, wherein said annular buss bar housing defines an outer circumference of said buss bar body, and said support defines a plurality of legs spaced about said buss bar body outer circumference.

4. The buss bar assembly of claim 1, wherein said support comprises a plurality of legs extending from said buss bar body in at least one of radially outwardly of said buss bar central axis and in a direction generally along said buss bar central axis.

5. The buss bar assembly of claim 1, wherein said buss bar assembly is adapted for being held in place relative to a plurality of coil winding assemblies arranged about a stator central axis by retaining forces applied to said support both radially and axially relative to said buss bar central axis.

6. A buss bar assembly according to claim 1 also for electrically interconnecting neutral leads extending from coil winding assemblies of a stator, said buss bar assembly further comprising a substantially annular electrically conductive neutral bar substantially surrounding said buss bar central axis, said neutral bar electrically isolated from said phase bar within said buss bar assembly, said neutral bar at least partially disposed within said buss bar body, said neutral bar having a plurality of neutral contacts at locations about said buss bar central axis, said neutral contacts engageable from outside of said buss bar body and angularly spaced from each other about said buss bar central axis, said buss bar assembly further adapted for installation relative to a plurality of coil winding assemblies arranged about a stator central axis such that said plurality of neutral contacts is spaced from stator coil winding assemblies along the stator central axis and engaged with neutral leads extending from the coil winding assemblies.

7. The buss bar assembly of claim 1, wherein said buss bar body is a plastic dielectric material that has been over-molded relative to said phase bar.

8. The buss bar assembly of claim 1, wherein in said installed state said buss bar central axis substantially coincides with the stator central axis.

9. A buss bar assembly for electrically interconnecting phase leads extending from a plurality of individual first phase coil winding assemblies of a stator arranged about a stator central axis, said buss bar assembly comprising:
a substantially annular dielectric buss bar body defining a buss bar central axis;
a substantially annular first phase bar disposed about said buss bar central axis and at least partially disposed within said buss bar body, said first phase bar having contact locations about said buss bar central axis at which are first phase bar electrical connection terminals engagable from outside of said buss bar body, said first phase bar contact locations fixed relative to said buss bar body; and
said buss bar assembly having an installed state relative to a plurality of individual first phase coil winding assemblies in which its phase leads are connected to said first phase bar electrical connector terminals at said first phase bar contact locations, said buss bar body is disposed about the stator central axis, and said first phase bar contact locations are spaced from the coil winding assemblies along the stator central axis.

10. The buss bar assembly of claim 9, wherein said buss bar assembly is also for interconnecting neutral leads extending from the plurality of arranged first phase individual coil winding assemblies, further comprising:
a substantially annular neutral bar disposed about said buss bar central axis and at least partially disposed within said buss bar body, said neutral bar having contact locations about said buss bar central axis at which are neutral bar electrical connection terminals engagable from outside of said buss bar body, said neutral bar contact locations fixed relative to said buss bar body, said neutral bar and said first phase bar electrically isolated from each other within said buss bar assembly;
wherein in said installed state, neutral leads of the coil winding assemblies are connected to said neutral bar electrical connector terminals, and said neutral bar contact locations are spaced from the coil winding assemblies along the stator central axis.

11. The buss bar assembly of claim 9, wherein said buss bar assembly is also for interconnecting phase leads extending from respective pluralities of individual second, and third phase coil winding assemblies arranged about the stator central axis, further comprising;
a substantially annular second phase bar disposed about said buss bar central axis and at least partially disposed within said buss bar body, said second phase bar having contact locations about said buss bar central axis at which are second phase bar electrical connection terminals engagable from outside of said buss bar body, said second phase bar contact locations fixed relative to said buss bar body;
a substantially annular third phase bar disposed about said buss bar central axis and at least partially disposed within said buss bar body, said third phase bar having contact locations about said buss bar central axis at which are third phase bar electrical connection terminals engagable from outside of said buss bar body, said third phase bar contact locations fixed relative to said buss bar body, said first, second, and third phase bars electrically isolated from each other;
wherein in said installed state, phase leads of first, second, and third phase coil winding assemblies are respectively connected to said first phase bar, second phase bar, and third phase bar at their respective said contact locations, and said second phase bar and third phase bar contact locations are spaced from the coil winding assemblies along the stator central axis.

12. The buss bar assembly of 9, wherein said buss bar body comprises an annular housing within which said first phase bar is at least partially disposed and a plurality of legs extending from said housing in a direction along said buss bar central axis, said legs adapted for being disposed between said housing and the plurality of coil winding assemblies in said installed state;
whereby said first phase bar is electrically connected to coil winding assemblies only through phase leads extending between the coil winding assemblies and said first phase bar contact locations.

13. A method for installing a buss bar assembly to an arranged plurality of individual coil winding assemblies defining a stator central axis, comprising the steps of:
positioning a substantially annular dielectric housing of the buss bar assembly about the stator central axis;
relatively moving the buss bar assembly and the plurality of coil winding assemblies towards each other along the stator central axis and superposing the annular housing and the coil winding assemblies;
registering a support that extends from the housing with a coil winding assembly, thereby establishing relative radial and axial positions of the housing and the arranged plurality of coil winding assemblies;
interconnecting a plurality of phase leads that extend from the plurality of individual coil winding assemblies through a substantially annular phase bar at least partially disposed in the dielectric housing through electrical phase contacts at locations outside of the housing; and
retaining the buss bar assembly to the arranged plurality of coil winding assemblies through the support.

14. The method of claim 13, wherein said step of registering comprises a step of engaging the support and the arranged plurality of coil winding assemblies at a plurality of discrete locations about the stator central axis on the arranged plurality of coil winding assemblies.

15. The method of claim 13, wherein said step of registering comprises a step of registering a plurality of legs of the support that extend at least one of radially outwardly from the substantially annular housing and axially along the stator central axis, with the arranged plurality of coil winding assemblies at discrete locations about the stator central axis on the plurality of arranged coil winding assemblies.

16. The method of claim 15, wherein said step of retaining comprises steps of:
positioning an annular retainer about the stator central axis;
disposing the retainer about the support and into engagement with the support; and
securing the retainer relative to the arranged plurality of coil winding assemblies.

17. The method of claim 13, wherein said step of registering comprises a step of interengaging a pilot feature of one of the support and the arranged plurality of coil winding assemblies, and a mating receiving feature of the other of the support and the arranged plurality of coil winding assemblies.

18. The method of claim 13, wherein said steps of registering and interconnecting are performed substantially simultaneously.

19. The method of claim 13, further comprising a step of interconnecting a plurality of neutral leads that extend from the plurality of individual coil winding assemblies to a substantially annular neutral bar at least partially disposed in the dielectric housing through electrical neutral contacts at locations outside of the housing.

20. The method of claim 19, wherein said step of interconnecting a plurality of phase leads and said step of interconnecting a plurality of neutral leads are performed substantially simultaneously.
